(19) United States
(12) Patent Application Publication
(10) Pub. No.: US 2013/0130533 A1
(43) Pub. Date: May 23, 2013

(54) WIRING CONNECTION ASSEMBLY FOR MALE AND FEMALE WIRING CONNETORS

(71) Applicant: Shang Tsai WU, New Taipei City (TW)

(72) Inventor: Shang Tsai WU, New Taipei City (TW)

(21) Appl. No.: 13/301,233

(22) Filed: Nov. 21, 2011

(51) Int. Cl. H01R 13/62

(52) U.S. Cl. 439/345

(57) ABSTRACT

Disclosed are a male wiring connector, a female wiring connector for use with the male wiring connector, and a wiring connector assembly composed of the male wiring connector and the female wiring connector. The male wiring connector includes a main body and two engaging levers. The main body includes wiring terminals and is bilaterally provided with grooved extension seats that extend rearward of, and beyond the rear end of, the main body. Each engaging lever has a first end inserted in the corresponding grooved extension seat and a second end extending forward of and spaced from the main body. Each engaging lever also has an engaging hook between the first and second ends. The male wiring connector can be conveniently connected with and disconnected from the female wiring connector to increase wiring efficiency.

### BACKGROUND OF THE INVENTION

1. Technical Field

The present invention relates to a male wiring connector, a female wiring connector for use therewith, and a wiring connector assembly composed of the male wiring connector and the female wiring connector. More particularly, the present invention relates to a male wiring connector configured for easy connection and disconnection so as to enhance wiring efficiency, a female wiring connector for use with the male wiring connector, and a wiring connector assembly composed of the male and the female wiring connectors.

2. Description of Related Art

Wiring connectors are typically used in electronic devices to facilitate wire connection, so that wiring can be done in an easy and orderly fashion. For example, the wires of a certain component of an electronic device terminate with a male wiring connector, and the wires of another component of the electronic device terminate with a female wiring connector. Once the male wiring connector is inserted in and thereby electrically connected with the female wiring connector to form a wiring connector assembly, the two components are electrically connected for signal transmission.

Please refer to FIGS. 1 and 2 for a perspective view and a partial sectional view of a conventional male wiring connector respectively.

As shown in the drawings, a conventional male wiring connector 9 includes a main body 91 and two engaging levers 92 respectively provided on two lateral sides of the main body 91. The engaging levers 92 on the two lateral sides of the main body 91 are configured for engaging with a matching female wiring connector (not shown in FIG. 1 or 2) when the male wiring connector 9 is inserted in the female wiring connector.

However, as the engaging levers 92 on the two lateral sides of the main body 91 of the conventional male wiring connector 9 are usually integrally formed with the main body 91, the moment arm provided by each engaging lever 92 is limited by the dimensions of the main body 91.

More specifically, the moment arms of the engaging levers 92 are often so short that, when it is desired to detach the male wiring connector 9 by pressing the engaging levers 92, the short moment arms tend to hinder the application of a pressing force to the engaging levers 92 and therefore make it difficult to disengage the engaging arms 92 from the matching female wiring connector. As a result, the wiring operation becomes undesirably inefficient.

### BRIEF SUMMARY OF THE INVENTION

The present invention relates to a male wiring connector which includes a main body and two engaging levers.

The main body includes at least one wiring terminal. On each of two lateral sides of the main body is a grooved extension seat that extends rearward of the main body and beyond the rear end thereof. Each engaging lever has a first end and a second end. The first end of each engaging lever is inserted in the corresponding grooved extension seat of the main body, while the second end of each engaging lever extends forward of the main body and is spaced therefrom. Each engaging lever further has an engaging hook between the first end and the second end.

The structure described above allows easy connection and disconnection and hence contributes to high wiring efficiency.

More particularly, with the first end of each engaging lever being inserted in the corresponding grooved extension seat of the main body, and the engaging levers extending rearward of, and beyond the rear end of, the main body from the two lateral sides thereof, the engaging levers have longer moment arms than their prior art counterparts and hence can be more conveniently pressed in order to connect or disconnect the male wiring connector to or from a female wiring connector. Consequently, both connection and disconnection of the male wiring connector are made easier, and the wiring operation can be done more efficiently.

In addition, each of the grooved extension seats is provided with an engaging shoulder, and the first end of each engaging lever has a hook portion. Once the first ends of the engaging levers are respectively inserted in the grooved extension seats of the main body, the hook portions are engaged with the engaging shoulders respectively.

Further, the second end of each engaging lever has a pressing portion.

The present invention also relates to a female wiring connector to be used with the foregoing male wiring connector. The female wiring connector includes a frame, wherein the frame includes at least one wiring terminal and is formed with an insertion hole. An engaging groove is provided on each of two lateral sides of the frame, communicates with the insertion hole, and has an engaging end.

The present invention also relates to a wiring connector assembly composed of the foregoing male and female wiring connectors. The main body of the male wiring connector is inserted in the insertion hole of the female wiring connector such that the at least one wiring terminal of the male wiring connector is respectively and electrically connected with the at least one wiring terminal of the female wiring connector. Moreover, each engaging lever of the male wiring connector is inserted in the corresponding engaging groove of the female wiring connector, with the engaging hook of each engaging lever being engaged with the engaging end of the corresponding engaging groove.

### BRIEF DESCRIPTION OF THE SEVERAL VIEWS OF THE DRAWINGS

The structure as well as a preferred mode of use and advantages of the present invention will be best understood by referring to the following detailed description of some illustrative embodiments in conjunction with the accompanying drawings, in which:

FIG. 1 is a perspective view of a conventional male wiring connector;

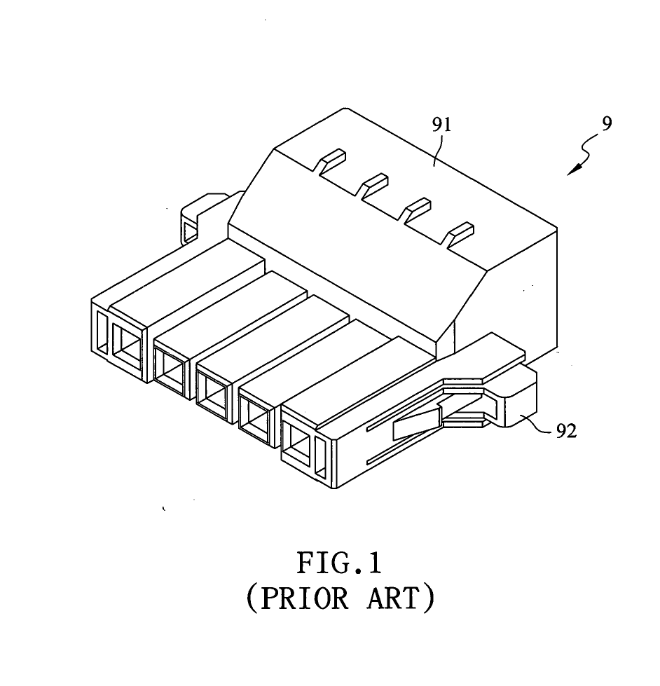

FIG. 2 is a partial sectional view of a conventional male wiring connector;

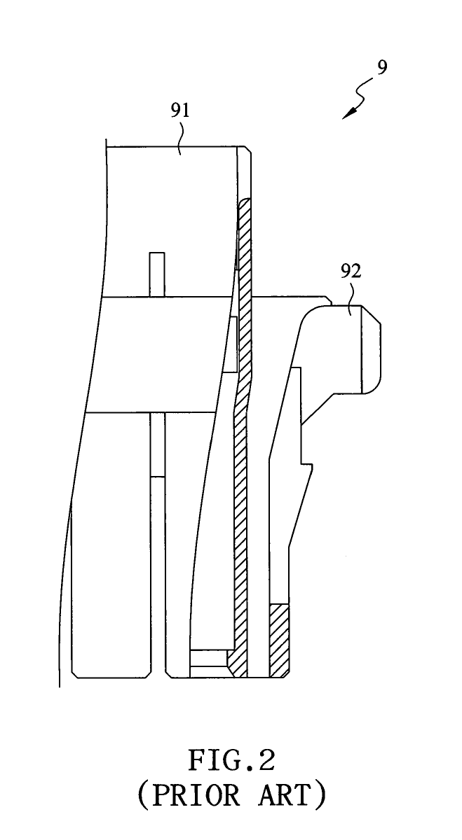

FIG. 3 is a perspective view of a male wiring connector according to a preferred embodiment of the present invention;

FIG. 4 is a partial sectional view of a male wiring connector according to a preferred embodiment of the present invention;

FIG. 5 is a perspective view of a female wiring connector according to a preferred embodiment of the present invention; and

FIG. 6 is a perspective view of a wiring connector assembly according to a preferred embodiment of the present invention.

### DETAILED DESCRIPTION OF THE INVENTION

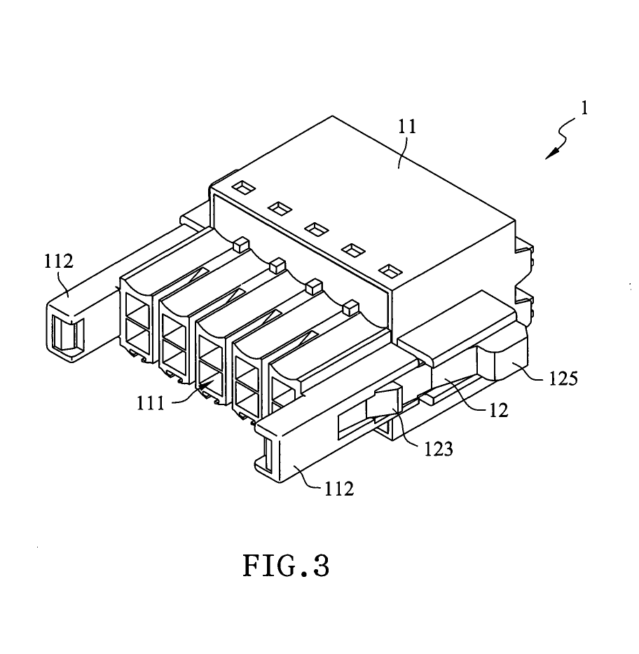

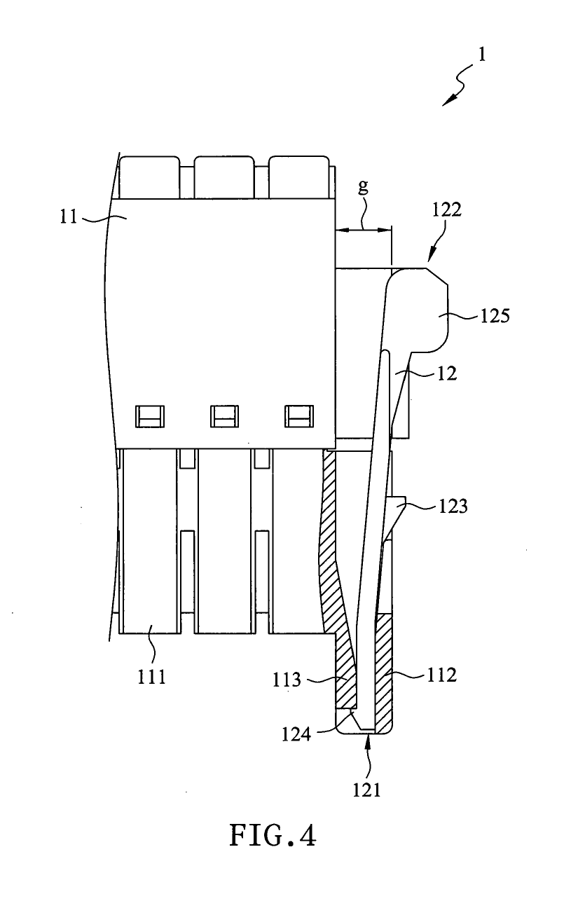

FIGS. 3 and 4 are respectively a perspective view and a partial sectional view of a male wiring connector according to a preferred embodiment of the present invention.

As shown in FIGS. 3 and 4, a male wiring connector 1 includes a main body 11 and two engaging levers 12.

The main body 11 includes at least one wiring terminal 111. A grooved extension seat 112 is provided on each of two lateral sides of the main body 11 and extends rearward of, and beyond the rear end of, the main body 11. Each engaging lever 12 has a first end 121 and a second end 122. The first end 121 of each engaging lever 12 is inserted in the corresponding one of the grooved extension seats 112 of the main body 11. The second end 122 of each engaging lever 12 extends forward of the main body 11 and is spaced from the main body 11 by a distance g. Each engaging lever 12 also has an engaging hook 123 between the first end 121 and the second end 122.

The aforesaid structure allows easy insertion and removal and helps increase wiring efficiency, as explained in more detail below.

As previously mentioned, the first end 121 of each engaging lever 12 is inserted in the corresponding grooved extension seat 112 of the main body 11, and each grooved extension seat 112 extends rearward from the two lateral sides of the main body 11 beyond the rear end of the main body 11. Therefore, the moment arm of each engaging lever 12 is increased in comparison with the prior art, and these relatively long moment arms make it easier to apply a pressing force to the engaging lever 12 when it is desired to insert or detach the male wiring connector 1 into or from a female wiring connector. In other words, the male wiring connector 1 can be more conveniently inserted or detached to facilitate the wiring operation.

In this embodiment, the main body 11 has a plurality of, or more specifically ten, wiring terminals 111. However, the number of the wiring terminals 111 is not limited to that disclosed herein.

Besides, each grooved extension seat 112 of the main body 11 has an engaging shoulder 113, and the first end 121 of each engaging lever 12 has a hook portion 124. When the first end 121 of each engaging lever 12 is inserted in the corresponding grooved extension seat 112 of the main body 11, the hook portions 124 are engaged with the engaging shoulders 113 respectively. This technical feature allows each engaging lever 12 to be securely positioned in the corresponding grooved extension seat 112 of the main body 11.

The second end 122 of each engaging lever 12 in this embodiment has a pressing portion 125 so that a pressing force can be easily applied to each engaging lever 12.

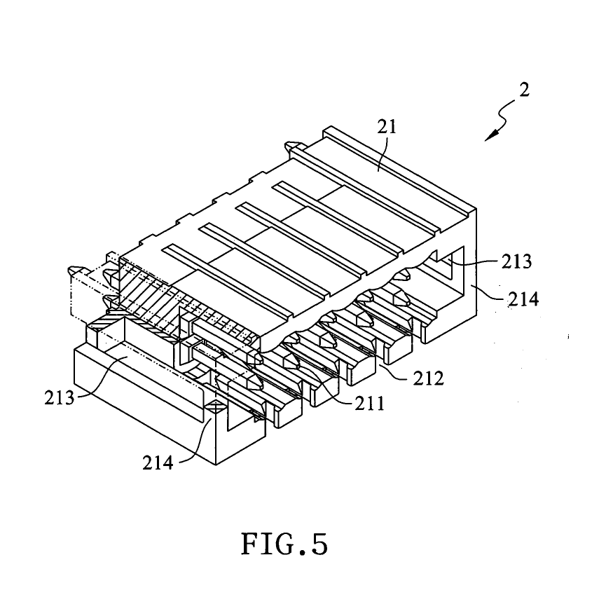

FIG. 5 is a perspective view of a female wiring connector according to a preferred embodiment of the present invention.

The female wiring connector 2 shown in FIG. 5 is configured for use with the male wiring connector 1 shown in FIGS. 3 and 4.

The female wiring connector 2 includes a frame 21. The frame 21 includes at least one wiring terminal 211 and is formed with an insertion hole 212. On each of two lateral sides of the frame 21 is an engaging groove 213. The engaging grooves 213 are in communication with the insertion hole 212 and each have an engaging end 214.

While the frame 21 is depicted in FIG. 5 as having ten wiring terminals 211, it is understood that the number of the wiring terminals 211 is not limited to ten.

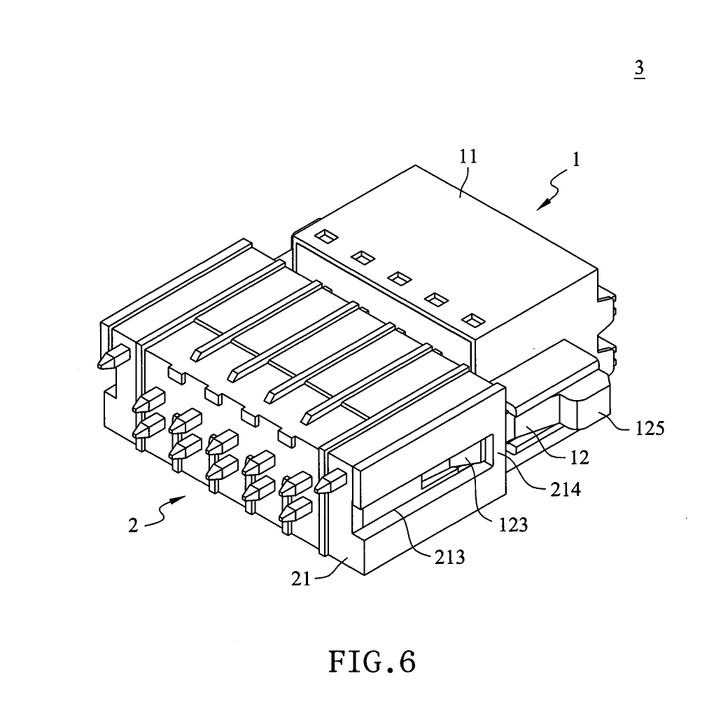

Reference is now made to FIGS. 3 to 6, wherein FIG. 6 is a perspective view of a wiring connector assembly according to a preferred embodiment of the present invention.

As shown in FIG. 6, a wiring connector assembly 3 is composed of the male wiring connector 1 in FIGS. 3 and 4 and the female wiring connector 2 in FIG. 5.

The main body 11 of the male wiring connector 1 is inserted in the insertion hole 212 of the female wiring connector 2, so as for the at least one wiring terminal 111 (i.e., the ten wiring terminals shown in FIGS. 3 and 4) of the male wiring connector 1 to be respectively and electrically connected with the at least one wiring terminals 211 (i.e., the ten wiring terminals shown in FIG. 5) of the female wiring connector 2. Meanwhile, each grooved extension seat 112 of the main body 11 of the male wiring connector 1 is inserted in the corresponding engaging groove 213 of the frame 21 of the female wiring connector 2. Thus, each engaging lever 12 of the male wiring connector 1 is inserted in the corresponding engaging groove 213 of the female wiring connector 2, and the engaging hook 123 of each engaging lever 12 is engaged with the engaging end 214 of the corresponding engaging groove 213.

According to the above description, the moment arm provided by each engaging lever 12 is longer than in the prior art. Hence, it is easier to apply a pressing force to each engaging lever 12, and the male wiring connector 1 can be inserted or detached more conveniently. Now that the male wiring connector 1 can be readily connected to and disconnected from the female wiring connector 2, the wiring operation can be carried out at high efficiency.

Furthermore, with the grooved extension seats 112 of the main body 11 of the male wiring connector 1 being respectively inserted in the engaging grooves 213 of the frame 21 of the female wiring connector 2, the male wiring connector 1 and the female wiring connector 2 once connected with each other will not get loose, thanks to the configuration of the grooved extension seats 112. In contrast to the prior art, in which a male wiring connector and a matching female wiring connector are generally designed for a loose fit (i.e., with a gap between the male and the female connectors in the connected state) to facilitate assembly, the male wiring connector 1 and the female wiring connector 2 of the present invention feature a securer connection that is less likely to become loose.

1. A male wiring connector, comprising:
a main body comprising at least a wiring terminal, the main body having two lateral sides each provided with a grooved extension seat extending rearward of the main body and beyond a rear end of the main body; and
two engaging levers, wherein each said engaging lever has a first end inserted in a corresponding one of the grooved extension seats of the main body, a second end extending forward of and spaced from the main body, and an engaging hook between the first end and the second end, wherein said first end of each of said levers, said second end of each of said levers and said engaging hook of each of said levers respectively extend perpendicular to said lateral sides.

2. The male wiring connector of claim 1, wherein each said grooved extension seat of the main body is provided with an engaging shoulder, and the first end of each said engaging lever has a hook portion and is inserted in the corresponding grooved extension seat of the main body in such a way that the hook portion is engaged with the engaging shoulder of the corresponding grooved extension seat.

3. The male wiring connector of claim 1, wherein the second end of each said engaging lever has a pressing portion extending perpendicular to respective ones of said lateral sides.

4. A female wiring connector for use with the male wiring connector of claim 1, the female wiring connector comprising a frame, wherein the frame comprises at least a wiring terminal, is formed with an insertion hole, and has an engaging groove on each of two lateral sides of the frame, each said engaging groove communicating with the insertion hole and having an engaging end.

5. A wiring connector assembly composed of the male wiring connector of claim 1 and the female wiring connector of claim 4, wherein the main body of the male wiring connector is inserted in the insertion hole of the female wiring connector, the at least a wiring terminal of the male wiring connector is respectively and electrically connected with the at least a wiring terminal of the female wiring connector, each said engaging lever of the male wiring connector is inserted in a corresponding one of the engaging grooves of the female wiring connector, and the engaging hook of each said engaging lever is engaged with the engaging end of the corresponding engaging groove.
